(19) United States
(12) Patent Application Publication
(10) Pub. No.: US 2009/0224117 A1
(43) Pub. Date: Sep. 10, 2009

(54) Suction cup device and article attaching apparatus

(75) Inventors: Hideo Kaneda, Tochigi (JP); Naotaka Kishi, Kanagawa (JP); Noboru Shiina, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/380,970

(22) Filed: Mar. 5, 2009

(30) Foreign Application Priority Data
Mar. 7, 2008 (JP) P2008-057498

(51) Int. Cl. F16B 47/00; A47B 96/06

(52) U.S. Cl. 248/206.3; 248/205.5

(57) ABSTRACT

Disclosed herein is a suction cup device, including: a suction cup having a suction face, and a rear face along a thicknesswise direction thereof; a center stem connected to a central portion of the rear face of the suction cup and extending in a direction away from the rear face along the thicknesswise direction; a case having a contacting portion capable of contacting with an outer circumferential portion of the rear face or with a portion of an attaching object face outside the suction cup; and a displacement mechanism provided between the center stem and the case for operating the case to cause the contacting portion of the case to contact with the outer circumferential portion of the rear face or the portion of the attaching object face outside the suction cup to displace the center stem in the direction away from the attaching object face.

### CROSS REFERENCES TO RELATED APPLICATIONS

The present invention contains subject matter related to Japanese Patent Application JP 2008-057498 filed in the Japan Patent Office on Mar. 7, 2008, the entire contents of which being incorporated herein by reference.

### BACKGROUND OF THE INVENTION

1. Field of the Invention

This invention relates to a suction cup device and an article attaching apparatus.

2. Description of the Related Art

A suction cup device is used to attach various articles to an attaching object face in the past.

Various suction cup devices of the type described have been proposed. One of such suction cup devices is generally configured such that it includes a suction cup having a suction face for being fixed to an attaching object face by suction, a center stem provided in a projecting manner from a rear face of the suction cup, a skirt member for covering the rear face of the suction cup, and an outer tubular member projecting from the center of the skirt member for accommodating the center stem therein. An article is connected to the outer tubular member of the suction cup device. A suction cup device of the type described is disclosed, for example, in Japanese Utility Model Laid-Open No. Hei 4-133773.

Incidentally, an article to be supported by such a suction cup device as described above may have such increased weight that it cannot be supported by a single suction cup device. In this instance, it seems a possible idea to take such a countermeasure that a plurality of suction cup devices are attached at the outer tubular members thereof to a frame in the form of a flat plate such that the center stems thereof extend perpendicularly to the frame and an article is attached to the frame such that the weight of the article is supported dispersedly by the plural suction cup devices.

### SUMMARY OF THE INVENTION

Incidentally, although there is no problem where the suction cups of the plural suction cup devices connected to each other by the frame in this manner are fixed to an attaching object face which lies in a single plane, where the attaching object face is formed from a curved face or the like, the following problem occurs.

In particular, since the center stems of the suction cups of the suction cup devices extend perpendicularly to the frame, if one of the suction cup is attached to an attaching object face in such a state that the center stem thereof extends perpendicularly to the attaching object face, then the center stem of the remaining suction cup or cups is placed into a state wherein it does not extend perpendicularly to the attaching object face in the form of a curved face but extends obliquely. Therefore, a gap is formed between the attaching face of the suction cup and the attaching object face, resulting in difficulty to attach the suction device stably to the attaching object face.

Therefore, it is desirable to provide an article attaching apparatus wherein a plurality of suction cup devices can be attached stably and with certainty to an attaching object face in the form of a curved face or the like by suction and which can be used advantageously for attachment of a heavy article and a suction cup device suitable for use with the article attaching apparatus.

According to an embodiment of the present invention, there is provided a suction cup device including a suction cup having a suction face and a rear face along a thicknesswise direction thereof, a center stem connected to a central portion of the rear face of the suction cup and extending in a direction away from the rear face along the thicknesswise direction, a case having a contacting portion capable of contacting with an outer circumferential portion of the rear face of the suction cup or with a portion of an attaching object face outside the suction cup in a state where the case covers the rear face of the suction cup and the suction face of the suction cup is attached to the attaching object face by suction, and a displacement mechanism provided between the center stem and the case for operating the case to cause the contacting portion of the case to contact with the outer circumferential portion of the rear face of the suction cup or the portion of the attaching object face outside the suction cup to displace the center stem in the direction away from the attaching object face in a state where the suction face of the suction cup is attached to the attaching object face by suction, the case having a male thread portion which extends in the direction away from the central portion of the rear face of the suction cup.

According to another embodiment of the present invention, there is provided an article attaching apparatus, including a frame connected to an article, and a plurality of suction cup devices connected to the frame, each of the suction cup devices including a suction cup having a suction face and a rear face along a thicknesswise direction thereof, a center stem connected to a central portion of the rear face of the suction cup and extending in a direction away from the rear face along the thicknesswise direction, a case having a contacting portion capable of contacting with an outer circumferential portion of the rear face of the suction cup or with a portion of an attaching object face outside the suction cup in a state where the case covers the rear face of the suction cup and the suction face of the suction cup is attached to the attaching object face by suction, and a displacement mechanism provided between the center stem and the case for operating the case to cause the contacting portion of the case to contact with the outer circumferential portion of the rear face of the suction cup or the portion of the attaching object face outside the suction cup to displace the center stem in the direction away from the attaching object face in a state where the suction face of the suction cup is attached to the attaching object face by suction, the case having a plurality of male thread portions which extend in the direction away from the central portion of the rear face of the suction cup, the frame having a plurality of screw fitting holes formed at different positions thereof spaced away from each other and having an inner diameter which allows the male thread portions of the case to be fitted in the screw fitting holes and allows tilting motion of the male thread portions in the state where the male thread portions are fitted in the screw fitting holes, the male thread portions of the case being fitted in the screw fitting holes in the frame while a pair of nuts are screwed on each of the male thread portions such that the frame is held between and by the nuts to connect the suction cup devices to the frame.

According to a further embodiment of the present invention, there is provided a suction cup device including a suction cup having a suction face and a rear face along a thicknesswise direction thereof, a center stem connected to a central portion of the rear face of the suction cup and extending in a direction away from the rear face along the thicknesswise direction, a case having a contacting portion capable of contacting with an outer circumferential portion of the rear face of the suction cup or with a portion of an attaching object face outside the suction cup in a state where the case covers the rear face of the suction cup and the suction face of the suction cup is attached to the attaching object face by suction, and a displacement mechanism provided between the center stem and the case for operating the case to cause the contacting portion of the case to contact with the outer circumferential portion of the rear face of the suction cup or the portion of the attaching object face outside the suction cup to displace the center stem in the direction away from the attaching object face in a state where the suction face of the suction cup is attached to the attaching object face by suction, an end portion of the center stem remote from the central portion of the rear face of the suction cup extending through the case so as to be exposed from the case, the center stem having a male thread portion provided at the portion thereof exposed from the case.

According to a still further embodiment of the present invention, there is provided an article attaching apparatus including a frame connected to an article, and a plurality of suction cup devices connected to the frame, each of the suction cup devices including a suction cup having a suction face and a rear face along a thicknesswise direction thereof, a center stem connected to a central portion of the rear face of the suction cup and extending in a direction away from the rear face along the thicknesswise direction, a case having a contacting portion capable of contacting with an outer circumferential portion of the rear face of the suction cup or with a portion of an attaching object face outside the suction cup in a state where the case covers the rear face of the suction cup and the suction face of the suction cup is attached to the attaching object face by suction, and a displacement mechanism provided between the center stem and the case for operating the case to cause the contacting portion of the case to contact with the outer circumferential portion of the rear face of the suction cup or the portion of the attaching object face outside the suction cup to displace the center stem in the direction away from the attaching object face in a state where the suction face of the suction cup is attached to the attaching object face by suction, the center stem having a plurality of male thread portions provided at the portion thereof exposed from the case, the frame having a plurality of screw fitting holes formed at different positions thereof spaced away from each other and having an inner diameter which allows the male thread portions of the case to be fitted in the screw fitting holes and allows tilting motion of the male thread portions in the state where the male thread portions are fitted in the screw fitting holes, the male thread portions of the case being fitted in the screw fitting holes in the frame while a pair of nuts are screwed on each of the male thread portions such that the frame is held between and by the nuts to connect the suction cup devices to the frame.

According to a yet further embodiment of the present invention, there is provided a suction cup device including a suction cup having a suction face and a rear face along a thicknesswise direction thereof, and a center stem connected to a central portion of the rear face of the suction cup and extending in a direction away from the rear face along the thicknesswise direction, the center stem having a male thread portion provided thereon.

According to a yet further embodiment of the present invention, there is provided an article attaching apparatus including a frame connected to an article, and a plurality of suction cup devices connected to the frame, each of the suction cup devices including a suction cup having a suction face and a rear face along a thicknesswise direction thereof, and a center stem connected to a central portion of the rear face of the suction cup and extending in a direction away from the rear face along the thicknesswise direction, the center stem having a plurality of male thread portions provided thereon, the frame having a plurality of screw fitting holes formed at different positions thereof spaced away from each other and having an inner diameter which allows the male thread portions of the case to be fitted in the screw fitting holes and allows tilting motion of the male thread portions in the state where the male thread portions are fitted in the screw fitting holes, the male thread portions of the case being fitted in the screw fitting holes in the frame while a pair of nuts are screwed on each of the male thread portions such that the frame is held between and by the nuts to connect the suction cup devices to the frame.

With the suction cup devices and the article attaching apparatus, a plurality of such suction cup devices can be attached stably and with certainty by suction to an attaching object face which may be formed from a curved face or the like, and a heavy article can be attached advantageously.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1A is a plan view of an article attaching apparatus according to a first embodiment of the present invention and FIG. 1B is a side elevational view of the article attaching apparatus as viewed in the direction indicated by an arrow mark B in FIG. 1A;

FIG. 2 is a sectional view showing a suction cup device of the article attaching apparatus in a non-attached state;

FIG. 3 is a side elevational view of the suction cup device in the state illustrated in FIG. 2;

FIG. 4 is a sectional view showing the suction cup device of the article attaching apparatus in an intermediately attached state;

FIG. 5 is a side elevational view of the suction cup device in the state illustrated in FIG. 4;

FIG. 6 is a sectional view showing the suction cup device of the article attaching apparatus in a finally attached state;

FIG. 7 is a side elevational view of the suction cup device in the state illustrated in FIG. 6;

FIG. 8A is a plan view of a frame of the article attaching apparatus and FIG. 8B is a side elevational view of the frame as viewed in the direction indicated by an arrow mark B in FIG. 8A;

FIG. 9A is a plan view of a nut of the article attaching apparatus and FIG. 9B is a side elevational view as viewed in the direction indicated by an arrow mark B in FIG. 9A;

FIG. 10 is a sectional view showing a male thread member of the article attaching apparatus attached to the frame;

FIG. 11 is a schematic side elevational view showing the article attaching apparatus attached to an attaching object face in the form of a curved face;

FIG. 12 is a schematic side elevational view showing a hook member of an article attaching apparatus according to a second embodiment of the present invention in a state where the hook member is attached to a frame;

FIG. 13A is a plan view of a plate-formed member of an article attaching apparatus according to a third embodiment of the present invention, FIG. 13B is a side elevational view as viewed in the direction indicated by an arrow mark B in FIG. 13A, and FIG. 13C is a side elevational view of a frame of the article attaching apparatus which is formed by placing two plate-formed members one on the other;

FIG. 14 is a side elevational view of the article attaching apparatus according to the third embodiment attached to a flat attaching object face;

FIG. 15 is a side elevational view of the article attaching apparatus according to the third embodiment attached to an attaching object face in the form of a curved face;

FIG. 16 is a plan view of an article attaching apparatus according to a fourth embodiment of the present invention;

FIG. 17 is a side elevational view of the article attaching apparatus as viewed in the direction indicated by an arrow mark A in FIG. 16;

FIGS. 18, 19 and 20 are plan views of article attaching apparatus according to fifth, sixth and seventh embodiments of the present invention, respectively;

FIG. 21 is a side elevational view of the article attaching apparatus of FIG. 20 as viewed in the direction indicated by an arrow mark A in FIG. 20;

FIG. 22A is a plan view of a suction cup having a large diameter, FIG. 22B is a schematic side elevational view illustrating operation of the suction cup of FIG. 22A, FIG. 22C is a plan view of the article attaching apparatus of FIG. 20, and FIG. 22D is a schematic side elevational view illustrating operation of the suction cup of FIG. 22C;

FIG. 23 is a sectional view of a suction cup device according to an eighth embodiment of the present invention;

FIG. 24 is a schematic side elevational view of the suction cup device of FIG. 23;

FIG. 25 is a sectional view of a suction cup device according to a ninth embodiment of the present invention;

FIG. 26 is a schematic side elevational view of the suction cup device of FIG. 25;

FIG. 27 is a sectional view of a suction cup device according to a modification to the ninth embodiment of the present invention;

FIG. 28 is a schematic side elevational view of the modified suction cup device of FIG. 27;

FIG. 29 is a sectional view of a suction cup device according to another modification to the ninth embodiment of the present invention; and

FIG. 30 is a schematic side elevational view of the modified suction cup device of FIG. 29.

### DETAILED DESCRIPTION OF THE PREFERRED EMBODIMENTS

### First Embodiment

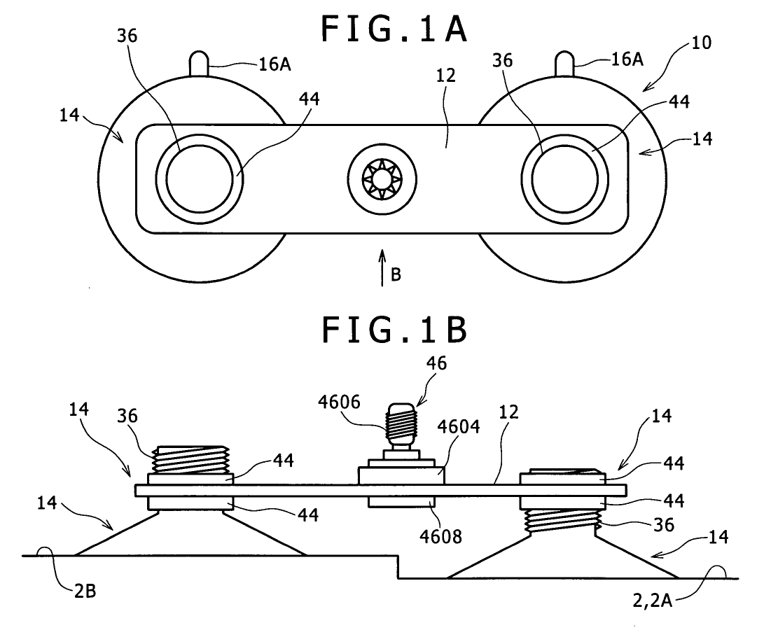

Referring first to FIGS. 1A and 1B, there is shown an article attaching apparatus 10 according to a first embodiment of the present invention. The article attaching apparatus 10 is used, for example, to support a display panel of a car navigation system or a television apparatus on a dashboard in a cabin of an automobile or to support a controller for remotely controlling various vehicle-carried apparatus or the like.

The article attaching apparatus 10 includes a frame 12 and a plurality of suction cup devices 14.

### (Suction Cup Device 14)

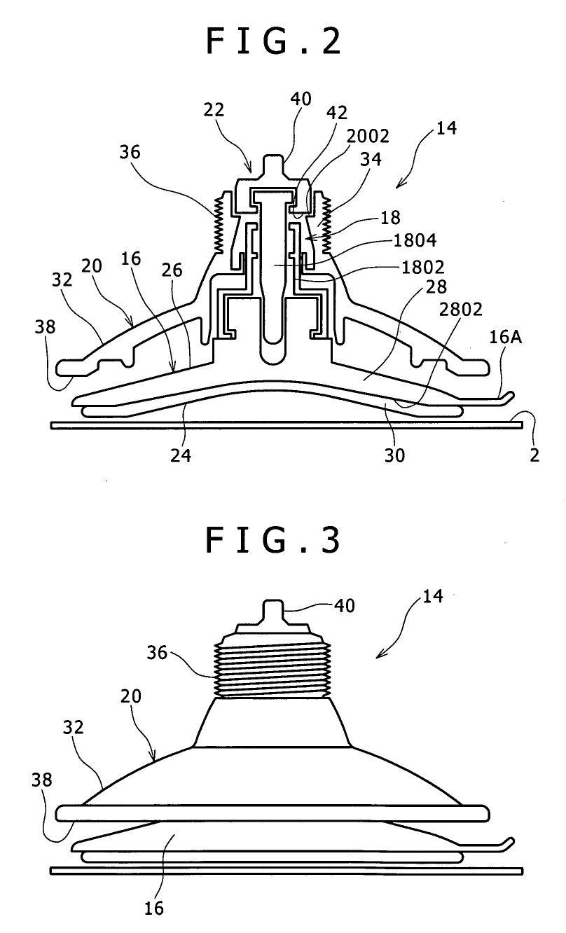

Referring to FIGS. 2 and 3, each of the suction cup devices 14 includes a suction cup 16, a center stem 18, a case 20, a displacement mechanism 22 and so forth.

The suction cup 16 has a shape of a disk, and one of the opposite faces of the suction cup 16 in the thicknesswise direction is formed as an attaching face 24 while the other face is formed as a rear face 26 of a convex configuration.

The suction cup 16 is made of a synthetic resin material having elasticity, and, for example, urethane-based materials, styrene-based materials, silicon resin-based materials and various elastic materials known in the past which are used for existing suction cups can be used as the synthetic resin material.

It is to be noted that a piece portion 16A for being operated to detach the suction cup 16 is provided on an outer edge of the suction cup 16 such that it extends in a diametrically outward direction of the suction cup 16.

The suction cup 16 may include, for example, a suction cup body 28 in the form of a disk which forms the rear face 26 and a gel layer 30 which forms the attaching face 24.

The suction cup body 28 may be made of a synthetic resin material having elasticity similarly to the suction cup 16 described hereinabove, and a synthetic resin material having elasticity such as, for example, urethane-based materials, styrene-based materials, silicon resin-based materials and various elastic materials known in the past which are used for existing suction cups can be used as the synthetic resin material similarly to the suction cup 16 described above.

The gel layer 30 is formed from gel and is joined to an attaching face 2802 formed in a concave shape on a face of the suction cup body 28 positioned remotely from the rear face 26 in such a manner as to cover over the attaching face 2802. The attaching face 24 is formed from the surface of the gel layer 30.

For the gel, synthetic resin-based gel such as polyethylene-based gel, styrene-based gel or silicon resin-based gel can be used, and as the polyethylene-based gel, for example, gel of the trade name “Cosmogel” by Cosmo Instruments Co., Ltd. which is an article on the market can be used. As the styrene-based gel, a gel of the trade name “NAGFRLEX” by Inoac Corporation which also is an article on the market can be used. As the silicon-based gel, for example, gel of the trade name “αGEL” (alpha gel) of TAICA CORPORATION which also is an article on the market can be used.

Further, for the joining of the gel layer 30 to the attaching face 2802, for example, such a method as two-color molding or joining by a bonding agent can be adopted.

If the attaching face 24 is formed from the gel layer 30, then even where an attaching object face 2 is formed as a leather embossed face or from a fine projection and recess face or else as a coarse face, the attaching face 24 deforms following up the face geometry. Consequently, the attaching face 24 can be contacted closely with the projection and recess face or coarse face. This is advantageous where various articles are attached with certainty to the attaching object face 2 such as a leather embossed face of a dashboard or the like.

The center stem 18 is connected to a central portion of the rear face 26 of the suction cup 16 and extends in a direction away from the rear face 26. In other words, the center stem 18 is provided at a central portion of the rear face 26 of the suction cup 16 in a projecting manner in a thicknesswise direction of the suction cup 16 along the center axis of the attaching face 24 in a direction away from the rear face 26.

The center stem 18 is made of a material having rigidity such as, for example, a metal material or a hard synthetic resin material and is embedded at a lower end thereof at a swollen portion at the center of the suction cup 16.

In the present embodiment, the center stem 18 includes a tubular member 1802 connected to the central portion of the rear face 26 and a stem-like member 1804 disposed in the inside of the tubular member 1802 and embedded at the central portion of the rear face 26.

The case 20 has a skirt portion 32, an outer side tubular portion 34, a male thread portion 36 and so forth and is formed from a material having rigidity such as a hard synthetic resin material.

The skirt portion 32 has a contacting portion 38 which covers the rear face 26 of the suction cup 16 and is capable of contacting with an outer circumferential portion of the rear face 26 or with a portion of the attaching object face 2 outside the suction cup 16 in a state where the attaching face 24 is fixed to the attaching object face 2 by suction.

The outer side tubular portion 34 stands uprightly from the center of the skirt portion 32 and has the center stem 18 accommodated on the inner side thereof.

The male thread portion 36 is formed coaxially with the center stem 18 at a portion of the case 20 spaced away from the central portion of the rear face 26 of the suction cup 16.

In the present embodiment, the male thread portion 36 is provided at an upper portion of the outer side tubular portion 34.

The displacement mechanism 22 is provided between the center stem 18 and the case 20 such that, in a state where the attaching face 24 is fixed to the attaching object face 2 by suction, the contacting portion 38 is contacted with the outer circumferential portion of the rear face 26 or with a portion of the attaching object face 2 outside the suction cup 16 to displace the center stem 18 in a direction away from the attaching object face 2.

In the present embodiment, the displacement mechanism 22 includes a knob 40 and a cam 42.

The knob 40 is disposed for rotation at an upper end of the stem-like member 1804, and the cam 42 is provided on an outer periphery of a lower end of the knob 40.

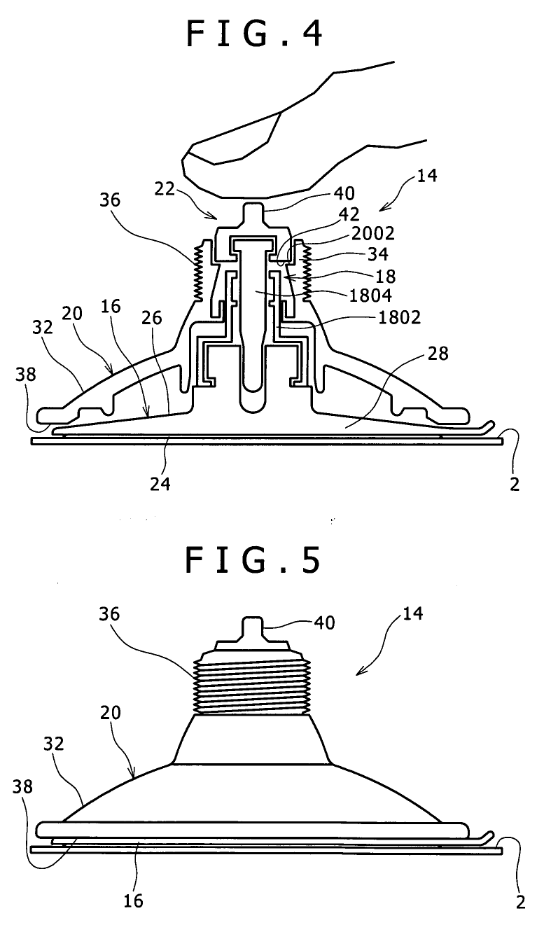

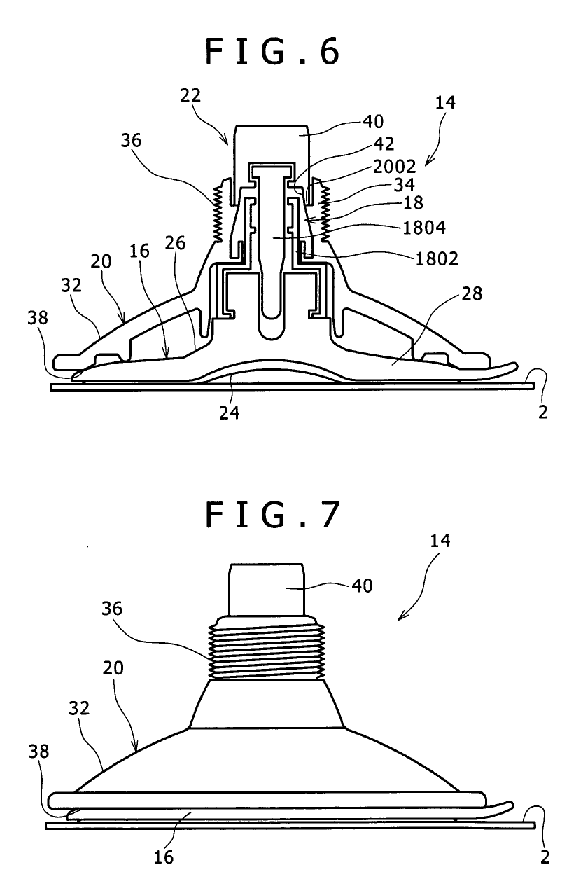

If the contacting portion 38 is contacted with the outer peripheral portion of the rear face 26 or with the portion of the attaching object face 2 outside the suction cup 16 in a state where the attaching face 24 is fixed to the attaching object face 2 by suction as seen in FIGS. 4 and 5 and then the knob 40 is operated for rotation as seen in FIGS. 6 and 7, then the cam 42 rides on a bearing face 2002 of the case 20 to displace the center stem 18 in a direction away from the attaching object face 2.

Consequently, the fixation of the attaching face 24 to the attaching object face 2 is made surer.

It is to be noted that, for the configuration of the displacement mechanism 22 which causes the contacting portion 38 to contact with the outer peripheral portion of the rear face 26 or with the portion of the attaching object face 2 outside the suction cup 16 in a state where the attaching face 24 is fixed to the attaching object face 2 by suction to displace the center stem 18 in a direction away from the attaching object face 2, various structures known in the past such as, for example, a structure which uses a spring can be adopted. Thus, the configuration of the displacement mechanism 22 is not limited to the structure of the embodiment described above.

### (Frame 12)

The frame 12 is provided to allow a plurality of suction cup devices 14 to support an article and interconnects the suction cup devices 14 while it is connected to an article.

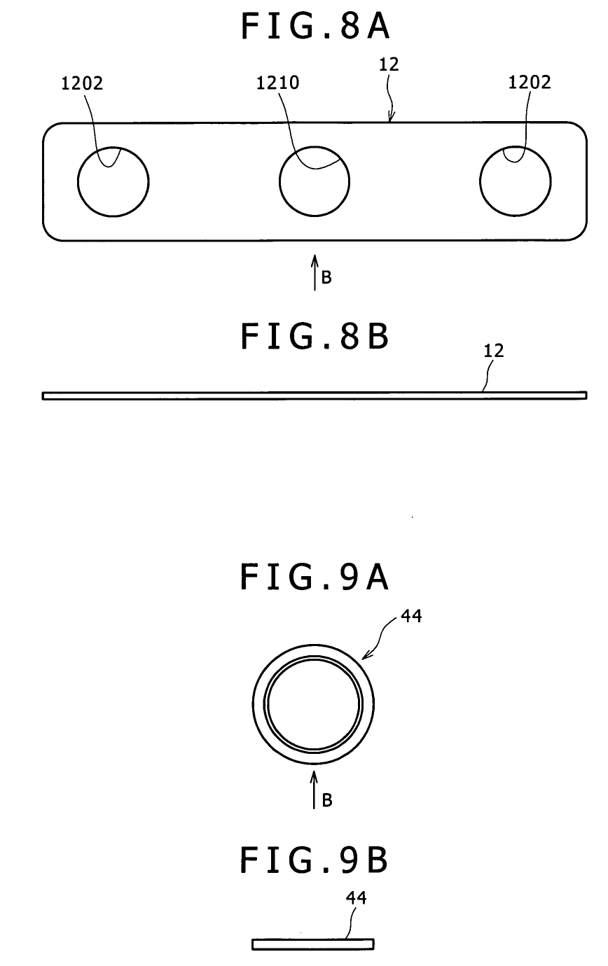

Referring to FIGS. 8A and 8B, the frame 12 has a form of a plate having a uniform width and a uniform thickness and has a pair of screw fitting holes 1202 formed at the opposite ends in the longitudinal direction thereof such that the male thread portion 36 can be fitted in each of the screw fitting holes 1202.

Each of the screw fitting holes 1202 is formed with an inner diameter greater than the diameter of the screw thread of the male thread portion 36 but smaller than the profile of a nut 44 shown in FIGS. 9A and 9B. Further, the screw fitting hole 1202 is formed with a dimension with which the male thread portion 36 can be tilted in the screw fitting hole 1202.

Referring to FIG. 1B, attachment of the male thread portion 36 of the frame 12 is carried out such that the frame 12 is held by and between a pair of nuts 44 screwed on the male thread portion 36 fitted in the screw fitting hole 1202 and opposed to the opposite faces of the frame 12.

Further, referring to FIG. 1b, an article connecting member 46 for connecting an article is provided uprightly at a central portion in the longitudinal direction of the frame 12.

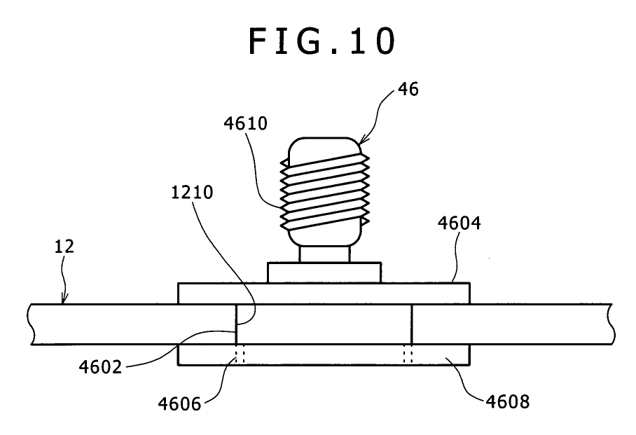

Referring to FIG. 10, the article connecting member 46 includes a stem portion 4602 fitted, for example, in a hole 1210 of the frame 12, an upper flange 4604 provided at one of the opposite ends of the stem portion 4602, a male thread 4606 provided at the opposite end of the stem portion 4602, a female thread member 4608 screwed on the male thread 4606 for cooperating with the upper flange 4604 to held the frame 12 therebetween, and so forth. A male thread 4610 for being coupled to an article is provided on the upper flange 4604.

If a male thread of ¼-20 UNC (inches) corresponding to a female thread for mounting a tripod provided on a housing of an image pickup apparatus such as a digital still camera, a film camera or a video camera is used as the male thread 4610, then it is possible to attach the image pickup apparatus to the article attaching apparatus 10 through the article connecting member 46 and use the image pickup apparatus readily.

### (Method of Use)

Now, a method of use of the article attaching apparatus 10 is described.

The male thread portions 36 are fitted into the screw fitting holes 1202 of the frame 12 in a state where one nut 44 is screwed to the base end of the male thread portion 36 of each suction cup device 14 in advance.

In this state, the attaching face 24 of the suction cup 16 of each suction cup device 14 is attached by suction to the attaching object face 2 to which the article attaching apparatus 10 is to be attached. Then, the knob 40 is operated to rotate to displace the center stem 18 in a direction away from the attaching object face 2 through the displacement mechanism 22 so that the attaching face 24 is fixed with certainty to the attaching object face 2 by suction.

Thereafter, the male thread portions 36 are fitted into the screw fitting holes 1202 and another nut 44 is screwed to each of the male thread portions 36 such that a portion of the frame 12 is held by and between the nut 44 and the cooperative nut 44 to connect the suction cup device 14 to the frame 12.

Consequently, the frame 12 and the article connecting member 46 are attached to the attaching object face 2 through the plural suction cup devices 14.

Here, by connecting the article connecting member 46 to an article, the article is attached to the attaching object face 2 through the frame 12 and the plural suction cup devices 14.

Here, if two attaching object faces 2A and 2B are formed from flat faces extending in parallel to each other and exhibit an offset in a direction perpendicular to the planes of the attaching object faces 2A and 2B as seen in FIG. 1B, then by adjusting the heightwise positions of the nuts 44 screwed to the male thread portions 36, an article can be attached stably to the attaching object faces 2A and 2B by the article attaching apparatus 10 in a state where the frame 12 and the attaching object faces 2A and 2B extend in parallel to each other.

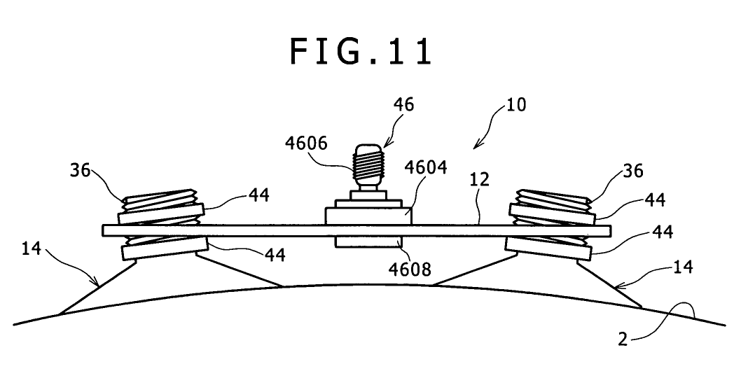

On the other hand, where the attaching object face 2 is a curved face as seen in FIG. 11, since the male thread portions 36 project in a direction perpendicular to the curved face, it is impossible to connect the male thread portions to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face. Further, since the frame 12 is held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

It is to be noted that removal of the article attaching apparatus 10 from the attaching object face 2 is carried out by picking up the piece portion 16A of each suction cup device 14 to remove the suction cup 16 from the attaching object face 2.

Accordingly, with the article attaching apparatus 10 of the present embodiment, the male thread portion 36 of each of the suction cup devices 14 is held by a portion of the frame through the nuts 44 in the state where the attaching faces 24 of the suction cups 16 of the plural suction cup devices 14 are fixed to the attaching object face 2 by suction. Therefore, the load applied to the frame 12 can be supported dispersedly by the plural suction cup devices 14.

Accordingly, the article attaching apparatus 10 advantageously makes it possible to increase the load of the article which can be attached to the attaching object face 2 and makes it possible to attach an article, which cannot be attached in the past, to the attaching object face 2. This is advantageous where improvement in convenience in handling of an article is achieved.

### Second Embodiment

Now, a second embodiment of the present invention is described.

While, in the first embodiment, the article connecting member 46 includes the stem portion 4602, upper flange 4604, male thread 4606, female thread member 4608 and so forth, in the present second embodiment, the article connecting member 46 is formed from a hook member 48.

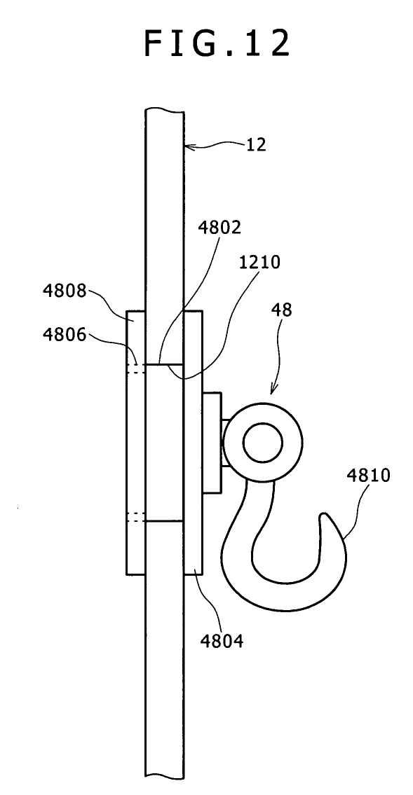

FIG. 12 illustrates attachment of the hook member 48 in the second embodiment to the frame 12.

Referring to FIG. 12, the hook member 48 includes a stem portion 4802 fitted, for example, in a hole 1210 of the frame 12, an upper flange 4804 provided at one end portion of the stem portion 4802, a male thread 4806 provide at the other end portion of the stem portion 4802, a female thread member 4808 screwed on the male thread 4806 for cooperating with the upper flange 4804 to hold the frame 12 therebetween, and so forth. The upper flange 4804 has a hook 4810 provided thereon for suspending an article.

Also the present second embodiment having the configuration described above naturally exhibits advantages similar to those of the first embodiment. Besides, where a wall face in a room is used as the attaching object face 2, a hanger for suspending clothes or the like can be suspended readily on the hook member 48. The convenience in use of the article attaching apparatus 10 is exhibited advantageously.

### Third Embodiment

Now, a third embodiment of the present invention is described.

The third embodiment is an article attaching apparatus 10 which includes three suction cup devices 14 and uses a frame 12 which includes two plate-formed members 1200.

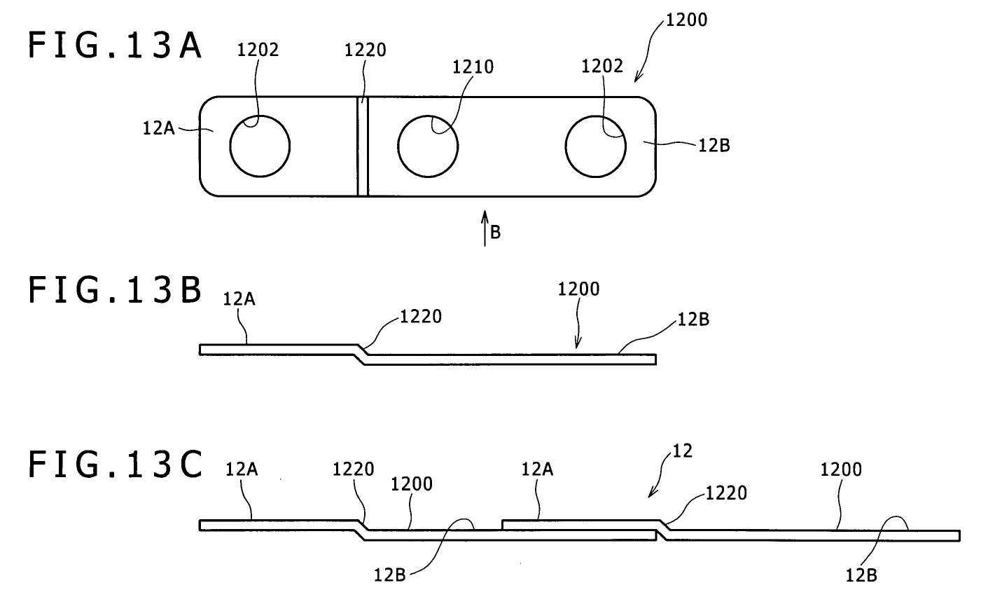

FIGS. 13A and 13B show one of the plate-formed members 1200, and FIG. 13C shows the frame 12 formed from the two plate-formed members 1200 placed one on the other.

The frame 12 includes two such plate-formed members 1200 as seen in FIG. 13C and each of the plate-formed members 1200 has a width of a dimension greater than that of the thickness thereof and has a length of a dimension greater than that of the width as seen in FIGS. 13A and 13B. Thus, the plate-formed member 1200 has a generally elongated rectangular shape as viewed in plan.

Each of the plate-formed members 1200 has a first plate portion 12A and a second plate portion 12B lying in different parallel planes spaced by a distance equal to the thickness thereof. The first plate portion 12A and the second plate portion 12B are juxtaposed in a longitudinal direction with each other and connected to each other through a bent portion 1220.

A pair of screw fitting holes 1202 are formed at the opposite ends in the longitudinal direction of each of the plate-formed members 1200.

Each of the screw fitting holes 1202 is formed with an inner diameter larger than the diameter of the screw thread of the male thread portion 36 but smaller than the profile of the nuts 44 similarly as in the first embodiment. Further, each screw fitting hole 1202 is formed with a dimension with which the male thread portion 36 can be tilted in the screw fitting hole 1202.

Meanwhile, a hole 1210 for receiving the stem portion 4602 of the article connecting member 46 therein is formed at a mid portion of each plate-formed member 1200.

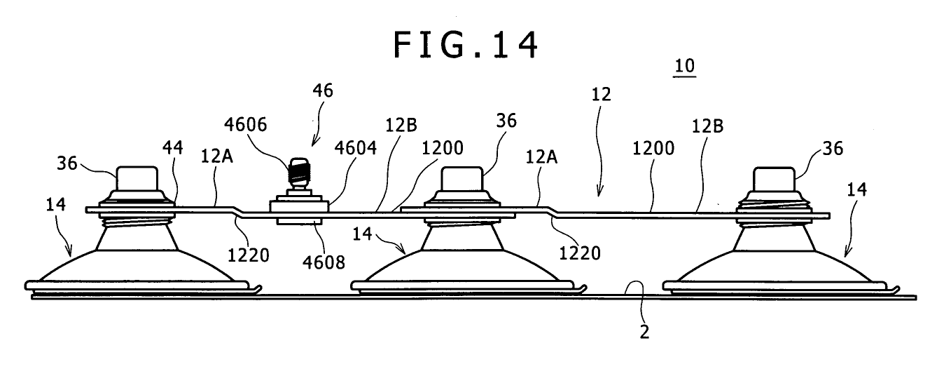

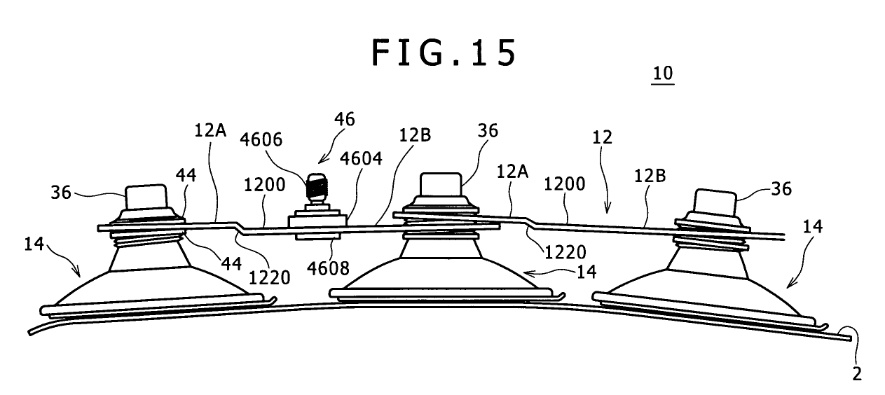

Referring now to FIGS. 14 and 15, the two plate-formed members 1200 are placed one on the other at portions thereof around one of the screw fitting holes 1202 thereof, and a male thread portion 36 is fitted in the overlapping screw fitting holes 1202. Another male thread portion 36 is fitted in the other one of the screw fitting holes 1202 of each of the plate-formed members 1200. A pair of nuts 44 are fitted on each male thread portion 36 and hold the plate-formed member 1200 therebetween to connect the suction cup device 14 to the plate-formed members 1200.

Meanwhile, the stem portion 4602 of the article connecting member 46 is inserted in the hole 1210 of one of the plate-formed members 1200, and the female thread member 4608 is used to connect the article connecting member 46 to the plate-formed member 1200.

More particularly, the first plate portion 12A of one of the two plate-formed members 1200 is placed on the second plate portion 12B of the other one of the plate-formed members 1200 such that the screw fitting holes 1202 of the two plate-formed members 1200 are registered with each other.

Consequently, the two first plate portions 12A of the two plate-formed members 1200 are positioned at the same heightwise position in the thicknesswise direction of the plate-formed members 1200, and the two second plate portions 12B are positioned at the same heightwise position but different from that of the first plate portions 12A.

With the configuration described above, the load applied to the frame 12 can be supported dispersedly by the three suction cup devices 14.

It is to be noted that it is optional to which one of the two plate-formed members 1200 the article connecting member 46 is attached or whether the article connecting member 46 is attached to one of the two plate-formed members 1200 or to both of the plate-formed members 1200, as shown in FIG. 13C.

Further, where portions of the attaching object face 2 to which the attaching faces 24 of the suction cups 16 of the suction cup devices 14 are attached by suction exhibit an offset or difference therebetween in a direction perpendicular to the planes of the attaching object face 2, the heightwise position of the nuts 44 screwed on the male thread portions 36 is adjusted. By this, an article can be attached to the attaching object face 2 by the article attaching apparatus 10 stably in a state where the plate-formed members 1200 of the frame 12 and the portions of the attaching object face 2 extend in parallel to each other similarly as in the case of the first embodiment.

On the other hand, where the attaching object face 2 is a curved face as seen in FIG. 15, since the male thread portions 36 project in a direction perpendicular to the curved face, it is impossible to connect the male thread portions 36 to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12, that is, the plate-formed members 1200, are held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

Accordingly, with the third embodiment of the present invention, the three suction cup devices 14 can be connected to each other by successively placing two plate-formed members 1200 one on another, and similar advantages to those of the first embodiment can be anticipated.

Further, since the first plate portion 12A and the second plate portions 12B which are displaced by an amount equal to the thickness of the plate-formed members 1200 in the thicknesswise direction of the plate-formed members 1200 are placed one on the other, the space occupied by the overlapping plate-formed members 1200 in the thicknesswise direction can be minimized. Consequently, the article attaching apparatus 10 of the present embodiment is superior in sight.

### Fourth Embodiment

Now, a fourth embodiment of the present invention is described.

The fourth embodiment is an article attaching apparatus 10 which uses three suction cup devices 14. In particular, the frame 12 includes three plate-formed members 1200 which are superposed one on another and connected to each other such that they individually extend along the three sides of a triangle.

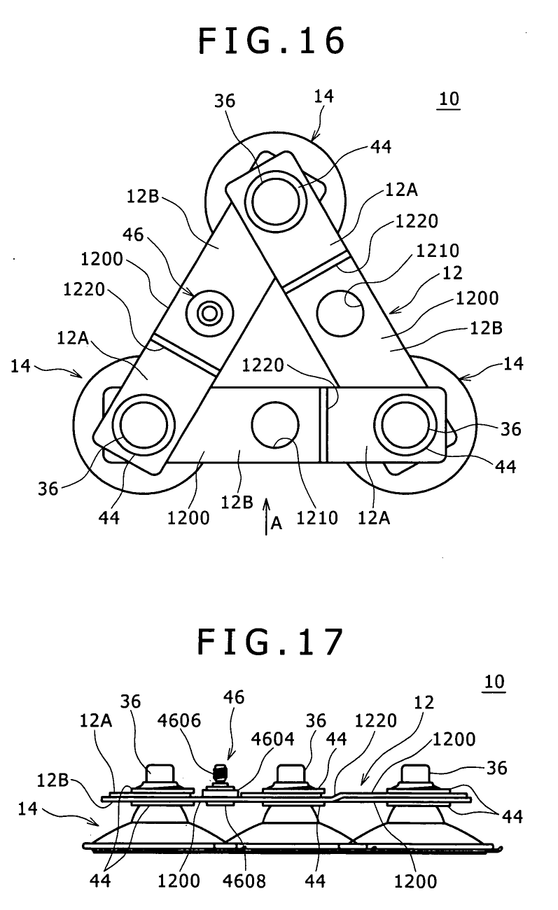

FIGS. 16 and 17 show the article attaching apparatus 10 according to the present fourth embodiment of the present invention.

Referring to FIGS. 16 and 17, each of the three plate-formed members 1200 has a width of a dimension greater than that of the thickness thereof and has a length of a dimension greater than that of the width as seen in FIGS. 16 and 17 similarly as in the third embodiment. Thus, the plate-formed member 1200 has a generally elongated rectangular shape as viewed in plan.

Each of the plate-formed members 1200 has a first plate portion 12A and a second plate portion 12B lying in different parallel planes spaced by a distance equal to the thickness thereof. The first plate portion 12A and the second plate portion 12B are juxtaposed in a longitudinal direction with each other and connected to each other through a bent portion 1220.

A pair of screw fitting holes 1202 are formed at the opposite ends in the longitudinal direction of each of the three plate-formed members 1200. The three plate-formed members 1200 are placed one on another at portions thereof around screw fitting holes 1202, and the male thread portions 36 are fitted in the overlapping screw fitting holes 1202. Further, the plate-formed members 1200 are held by and between the nuts 44 screwed on the male thread portions 36 with the overlapping plate-formed members 1200 interposed therebetween to connect the suction cup devices 14 to the plate-formed members 1200.

Meanwhile, the stem portion 4602 of the article connecting member 46 is inserted in a hole 1210 of one of the plate-formed members 1200, and the female thread member 4608 is used to connect the article connecting member 46 to the plate-formed member 1200.

More particularly, on the second plate portion 12B of a first one of the plate-formed members 1200, the first plate portion 12A of a second one of the plate-formed members 1200 is placed such that the screw fitting holes 1202 of the first and second plate-formed members 1200 are registered with each other.

Then, on the second plate portion 12B of the second plate-formed member 1200, the first plate portion 12A of a third one of the plate-formed members 1200 is placed such that the screw fitting holes 1202 of the second and third plate-formed members 1200 are registered with each other.

Further, on the second plate portion 12B of the third plate-formed member 1200, the first plate portion 12A of the first plate-formed member 1200 is placed such that the screw fitting holes 1202 of the first and third plate-formed members 1200 are registered with each other.

Consequently, the three first plate portions 12A of the three plate-formed members 1200 are positioned at the same heightwise position in the thicknesswise direction of the plate-formed members 1200, and the three second plate portions 12B are positioned at the same heightwise position but different from that of the first plate portions 12A.

With the configuration described above, the load applied to the frame 12 can be supported dispersedly by the three suction cup devices 14.

It is to be noted that it is optional to which one of the three plate-formed members 1200 the article connecting member 46 is attached or whether the article connecting member 46 is attached to one of the three plate-formed members 1200, two of the three plate-formed members 1200 or all of the three plate-formed members 1200.

Further, where portions of the attaching object face 2 to which the attaching faces 24 of the suction cups 16 of the suction cup devices 14 are attached by suction exhibit an offset or difference therebetween in a direction perpendicular to the planes of the attaching object face 2, the heightwise position of the nuts 44 screwed on the male thread portions 36 is adjusted. By this, an article can be attached to the attaching object face 2 by the article attaching apparatus 10 stably in a state where the plate-formed members 1200 of the frame 12 and the portions of the attaching object face 2 extend in parallel to each other similarly as in the case of the third embodiment.

On the other hand, where the attaching object face 2 is a curved face, since the male thread portions 36 project in a direction perpendicular to the curved face, it is impossible to connect the three male thread portions to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12, that is, the plate-formed members 1200, are held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

Accordingly, with the fourth embodiment of the present invention, the three suction cup devices 14 can be connected to each other by successively placing three plate-formed members 1200 one on another. Further, since the load to the frame 12 can be supported dispersed by the three suction cup devices 14, advantageously an article of increased weight can be supported stably.

Further, since the first plate portion 12A and the second plate portion 12B which are displaced by an amount equal to the thickness of the plate-formed members 1200 in the thicknesswise direction of the plate-formed members 1200 are placed one on the other, the space occupied by the overlapping plate-formed members 1200 in the thicknesswise direction can be minimized. Consequently, the article attaching apparatus 10 of the present embodiment is superior in sight.

### Fifth Embodiment

Now, a fifth embodiment of the present invention is described.

The fifth embodiment is an article attaching apparatus 10 which uses four suction cup devices 14. In particular, the frame 12 includes four plate-formed members 1200 which are superposed one on another and connected to each other such that they individually extend along the four sides of a parallelogram.

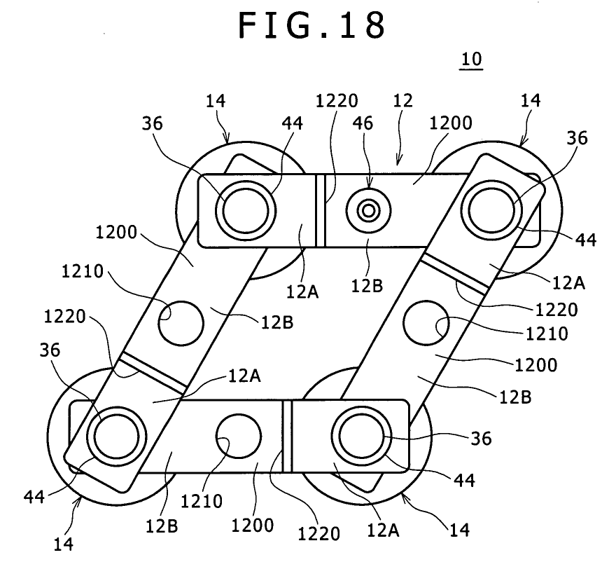

FIG. 18 shows the article attaching apparatus 10 according to the present fifth embodiment of the present invention.

Referring to FIG. 18, each of the four plate-formed members 1200 is formed in a similar manner as in the third embodiment.

The four plate-formed members 1200 are placed one on another at portions thereof around the screw fitting holes 1202, and the male thread portions 36 are fitted in the overlapping screw fitting holes 1202. Further, the plate-formed members 1200 placed one on another in this manner are held by and between the nuts 44 screwed on the male thread portions 36 with the overlapping plate-formed members interposed therebetween to connect the suction cup devices 14 to the plate-formed members 1200.

Meanwhile, the stem portion 4602 of the article connecting member 46 is inserted in the hole 1210 of one of the plate-formed members 1200, and the female thread member 4608 is used to connect the article connecting member 46 to the plate-formed member 1200.

More particularly, on the second plate portion 12B of a first one of the plate-formed members 1200, the first plate portion 12A of a second one of the plate-formed members 1200 is placed such that the screw fitting holes 1202 of the first and second plate-formed members 1200 are registered with each other.

Then, on the second plate portion 12B of the second plate-formed member 1200, the first plate portion 12A of a third one of the plate-formed members 1200 is placed such that the screw fitting holes 1202 of the second and third plate-formed members 1200 are registered with each other.

Further, on the second plate portion 12B of the third plate-formed member 1200, the first plate portion 12A of a fourth one of the plate-formed members 1200 is placed such that the screw fitting holes 1202 of the third and fourth plate-formed members 1200 are registered with each other.

Furthermore, on the second plate portion 12B of the fourth plate-formed member 1200, the first plate portion 12A of the first plate-formed member 1200 is placed such that the screw fitting holes 1202 of the first and fourth plate-formed members 1200 are registered with each other.

Consequently, the four first plate portions 12A of the four plate-formed members 1200 are positioned at the same heightwise position in the thicknesswise direction of the plate-formed members 1200, and the four second plate portions 12B are positioned at the same heightwise position but different from that of the first plate portions 12A.

With the configuration described above, the load applied to the frame 12 can be supported dispersedly by the four suction cup devices 14.

It is to be noted that it is optional to which one of the four plate-formed members 1200 the article connecting member 46 is attached or whether the article connecting member 46 is attached to one of the four plate-formed members 1200, two of the four plate-formed members 1200, three of the four plate-formed members 1200 or all of the four plate-formed members 1200.

Further, where portions of the attaching object face 2 to which the attaching faces 24 of the suction cups 16 of the suction cup devices 14 are attached by suction exhibit an offset or difference therebetween in a direction perpendicular to the planes of the attaching object face 2, the heightwise position of the nuts 44 screwed on the male thread portions 36 is adjusted. By this, an article can be attached to the attaching object face 2 by the article attaching apparatus 10 stably in a state where the plate-formed members 1200 of the frame 12 and the portions of the attaching object face 2 extend in parallel to each other similarly as in the case of the third embodiment.

On the other hand, where the attaching object face 2 is a curved face, since the male thread portions 36 project in a direction perpendicular to the curved face, it is impossible to connect the four male thread portions to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12, that is, the plate-formed members 1200, are held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

Accordingly, with the fifth embodiment of the present invention, the four suction cup devices 14 can be connected to each other by successively placing the four plate-formed members 1200 one on another. Further, since the load to the frame 12 can be supported dispersed by the four suction cup devices 14, advantageously an article of increased weight can be supported stably.

Further, since the first plate portion 12A and the second plate portion 12B which are displaced by an amount equal to the thickness of the plate-formed members 1200 in the thicknesswise direction of the plate-formed members 1200 are placed one on the other, the space occupied by the overlapping plate-formed members 1200 in the thicknesswise direction can be minimized. Consequently, the article attaching apparatus 10 of the present embodiment is superior in sight.

### Sixth Embodiment

Now, a sixth embodiment of the present invention is described.

The sixth embodiment is an article attaching apparatus 10 which uses five suction cup devices 14. In particular, the frame 12 includes four plate-formed members 1200 which are superposed one on another and connected to each other such that they extend along four straight lines connected angularly to each other.

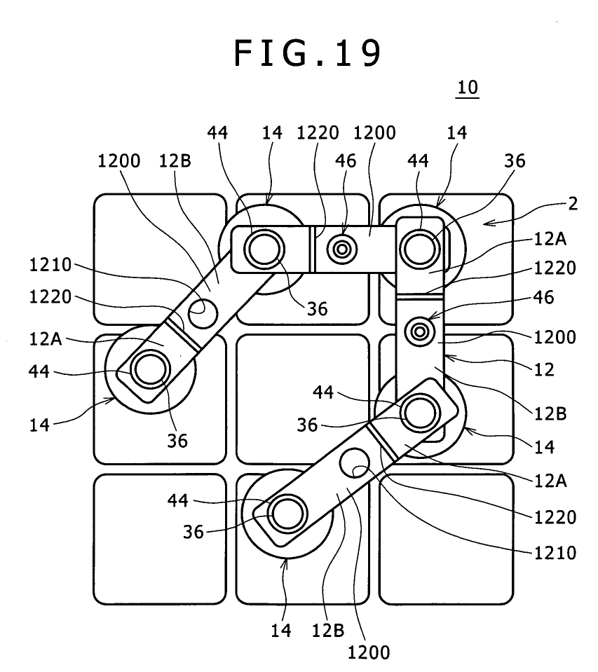

FIG. 19 shows the article attaching apparatus 10 according to the present sixth embodiment of the present invention.

Referring to FIG. 19, each of the four plate-formed members 1200 is formed in a similar manner as in the fourth embodiment.

The four plate-formed members 1200 are placed one on another at portions thereof around the screw fitting holes 1202, and the male thread portions 36 are fitted in the overlapping screw fitting holes 1202. Further, the plate-formed members 1200 placed one on another in this manner are held by and between the nuts 44 screwed on the male thread portions 36 with the overlapping plate-formed members 1200 interposed therebetween to connect the suction cup devices 14 to the plate-formed members 1200.

Meanwhile, the stem portion 4602 of the article connecting member 46 is inserted in the hole 1210 of each of two ones of the plate-formed members 1200, and the female thread member 4608 is used to connect each of the article connecting members 46 to the plate-formed member 1200.

More particularly, on the second plate portion 12B of a first one of the plate-formed members 1200, the first plate portion 12A of a second one of the plate-formed members 1200 is placed such that the screw fitting holes 1202 of the first and second plate-formed members 1200 are registered with each other.

Then, on the second plate portion 12B of the second plate-formed member 1200, the first plate portion 12A of a third one of the plate-formed members 1200 is placed such that the screw fitting holes 1202 of the second and third plate-formed members 1200 are registered with each other.

Further, on the second plate portion 12B of the third plate-formed member 1200, the first plate portion 12A of a fourth one of the plate-formed members 1200 is placed such that the screw fitting holes 1202 of the third and fourth plate-formed members 1200 are registered with each other.

With the configuration described above, the load applied to the frame 12 can be supported dispersedly by the five suction cup devices 14.

Further, where portions of the attaching object face 2 to which the attaching faces 24 of the suction cups 16 of the suction cup devices 14 are attached by suction exhibit an offset or difference therebetween in a direction perpendicular to the planes of the attaching object face 2, the heightwise position of the nuts 44 screwed on the male thread portions 36 is adjusted. By this, an article can be attached to the attaching object face 2 by the article attaching apparatus 10 stably in a state where the plate-formed members 1200 of the frame 12 and the portions of the attaching object face 2 extend in parallel to each other similarly as in the case of the third embodiment.

On the other hand, where the attaching object face 2 is a curved face, since the male thread portions 36 project in a direction perpendicular to the curved face, it is impossible to connect the five male thread portions to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12, that is, the plate-formed members 1200, are held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

Accordingly, even if the portion of the attaching object face 2 to which the suction cup device 14 attached to the first plate-formed member 1200 is fixed by suction and the portion of the attaching object face 2 to which the suction cup device 14 attached to the fourth plate-formed member 1200 is fixed by suction exhibit a great difference in height therebetween, since the first plate-formed member 1200 and the fourth plate-formed member 1200 are not directly connected to each other, the article attaching apparatus 10 can be attached simply and with certainty to two different places of the attaching object face 2 which are much different in height from each other.

It is to be noted that it is optional to which one of the four plate-formed members 1200 the article connecting member 46 is attached or whether the article connecting member 46 is attached to one of the four plate-formed members 1200, two of the four plate-formed members 1200, three of the four plate-formed members 1200 or all of the four plate-formed members 1200.

Accordingly, with the sixth embodiment of the present invention, the five suction cup devices 14 can be connected to each other by successively placing the four plate-formed members 1200 one on another. Further, since the load to the frame 12 can be supported dispersed by the five suction cup devices 14, advantageously an article of increased weight can be supported stably.

### Seventh Embodiment

Now, a seventh embodiment of the present invention is described.

The seventh embodiment is an article attaching apparatus 10 which uses three suction cup devices 14 and includes a frame 12 in the form of a single disk.

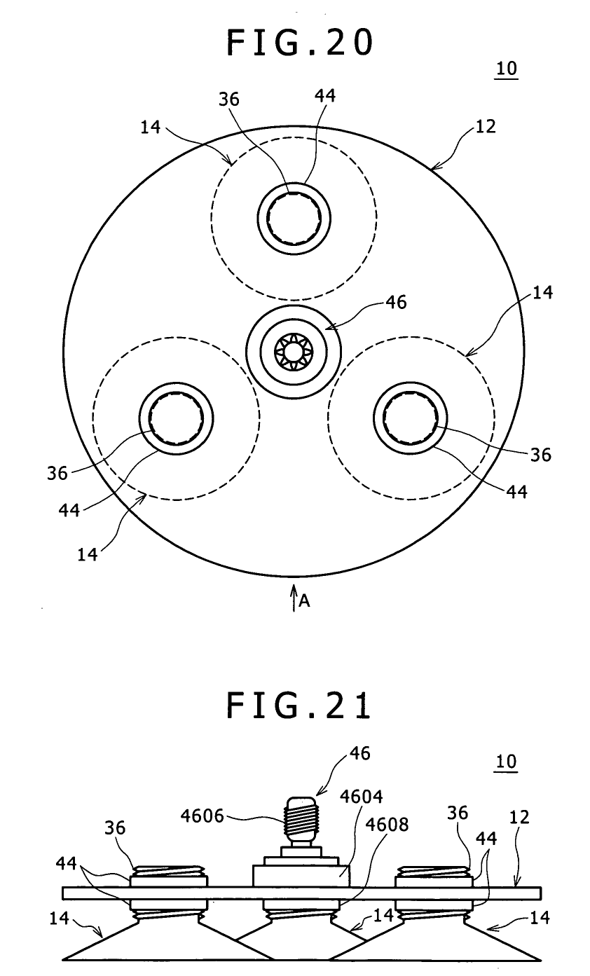

FIGS. 20 and 21 show the article attaching apparatus 10 according to the seventh embodiment of the present invention.

Referring to FIGS. 20 and 21, the frame 12 has a form of a disk of a uniform thickness and has three screw fitting holes 1202 formed therein in an equally spaced relationship from each other on a circumference centered at the center of the frame 12. Further, the frame 12 has a hole 1210 formed at the center thereof.

Similarly as in the first embodiment, each of the screw fitting holes 1202 is formed with an inner diameter larger than the diameter of the screw thread of the male thread portion 36 but smaller than the profile of the nuts 44. Further, each screw fitting hole 1202 is formed with a dimension with which the male thread portion 36 can be tilted in the screw fitting hole 1202.

A male thread portion 36 of a suction cup device 14 is fitted in each of the three screw fitting holes 1202, and the frame 12 is held by and between a pair of nuts 44 screwed on the male thread portion 36 of the suction cup device 14 to connect the suction cup device 14 to the frame 12.

Meanwhile, a stem portion 4602 of an article connecting member 46 is fitted in the hole 1210 of the frame 12, and a female thread member 4608 is used to connect the article connecting member 46 to the frame 12.

With the configuration described above, the load applied to the frame 12 can be supported dispersedly by the three suction cup devices 14.

Further, where portions of the attaching object face 2 to which the attaching faces 24 of the suction cups 16 of the suction cup devices 14 are attached by suction exhibit an offset or difference therebetween in a direction perpendicular to the planes of the attaching object face 2, the heightwise position of the nuts 44 screwed on the male thread portions 36 is adjusted. By this, an article can be attached to the attaching object face 2 by the article attaching apparatus 10 stably in a state where the frame 12 and the portions of the attaching object face 2 extend in parallel to each other similarly as in the case of the third embodiment.

On the other hand, where the attaching object face 2 is a curved face, since the male thread portions 36 project in a direction perpendicular to the curved face, it is impossible to connect the three male thread portions 36 to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12 is held by and between the nuts 44 screwed on the male thread portions 36, the article can be supported by the frame 12 in a state where the suction cup devices 14 are fixed with certainty by suction to the attaching object face 2 in the form of a curved face.

Accordingly, the article can be attached stably to the attaching object face 2 in the form of a curved face by the article attaching apparatus 10.

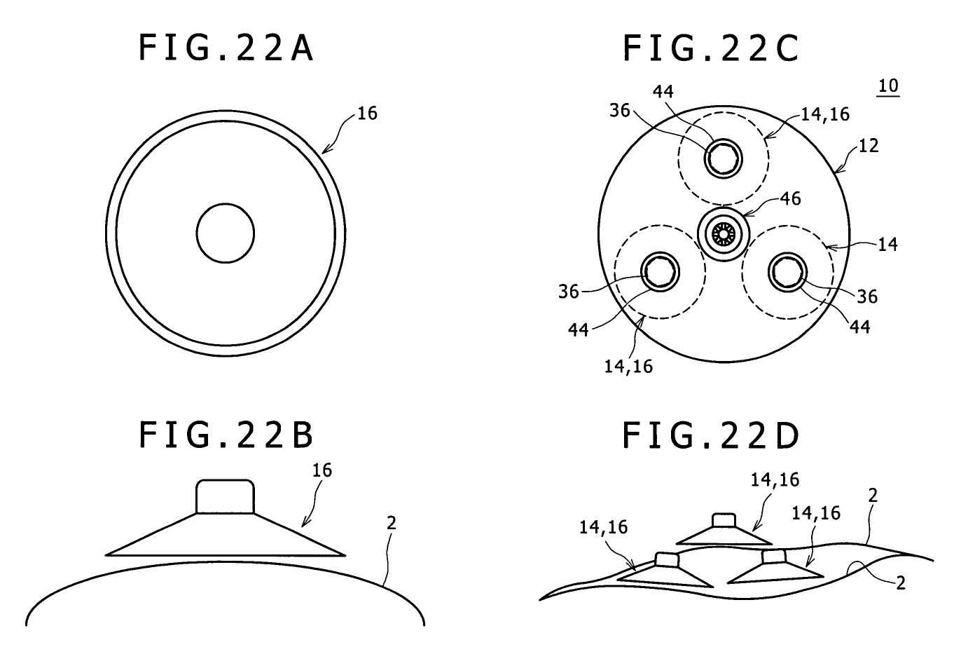

On the other hand, where a single suction cup 16 is to be fixed to the attaching object face 2 in the form of a curved face by suction, it is necessary for the suction cup 16 of the suction cup device 14 to be deformed following up the curvature of the attaching object face 2, as shown in FIGS. 22A and 22B.

Therefore, although the curvature of the attaching object face 2 which can be fixed by the suction cup 16 by suction must be increased as the diameter of the suction cup 16 increases, where the suction cup 16 has a large diameter and can support a high load, it is disadvantageous in that it cannot be fixed to the attaching object face 2 of a low curvature by suction.

In contrast, with the article attaching apparatus 10 of the seventh embodiment, a plurality of suction cup devices 14 having suction cups 16 of a small diameter which can follow up the curvature of the attaching object face 2 are connected to the frame 12 as seen in FIGS. 22C and 22D.

Thus, where the attaching object face 2 has a form of a curved face, since the male thread portions 36 project in a direction perpendicular to the curved face, it is impossible to connect the three male thread portions to each other in the past. However, with the article attaching apparatus 10 according to the present embodiment, since the male thread portions 36 of the suction cup devices 14 can be tilted within the screw fitting holes 1202 of the frame 12, the attaching faces 24 of the suction cup devices 14 can be fixed with certainty by suction to the attaching object face 2 in the form of a curved face similarly as in the first embodiment. Further, since the frame 12 is held by and between the nuts 44 screwed on the male thread portions 36, the article can be supported by the frame 12 in a state where the suction cup devices 14 are fixed with certainty by suction to the attaching object face 2 in the form of a curved face.

Therefore, even where the attaching object face 2 has a small curvature, the suction cups 16 can be fixed stably and with certainty to the attaching object face 2 by suction, and the load can be supported dispersedly by the plural suction cups 16.

Accordingly, the article attaching apparatus 10 of the seventh embodiment is advantageous in that, even to the attaching object face 2 of a small curvature, it can attach an article of a heavy weight stably and with certainty.

It is to be noted that also the first to sixth embodiments naturally achieve advantages similar to those achieved by the seventh embodiment.

It is to be noted that, while, in the first to seventh embodiments described above, the male thread portion 36 is provided on the case, the male thread portion 36 may otherwise be provided on the center stem 18.

In this instance, the male thread portion 36 is provided at a portion of the center stem which is remote from the central portion of the back face of the suction cup and is exposed from the case as the center stem extends through the case.

Also such a suction cup device and an article attaching apparatus wherein the male thread portion 36 is provided on the center stem 18 as described above achieve similar advantages to those achieved by the first to seventh embodiments.

### Eighth Embodiment

Now, an eighth embodiment of the present invention is described.

While, in the first to seventh embodiments described above, the male thread portion 36 is formed on the case 20 which covers the rear face 26 of the suction cup 16, according to the eighth embodiment, the male thread portion 36 is formed on the center stem 18 of the suction cup 16.

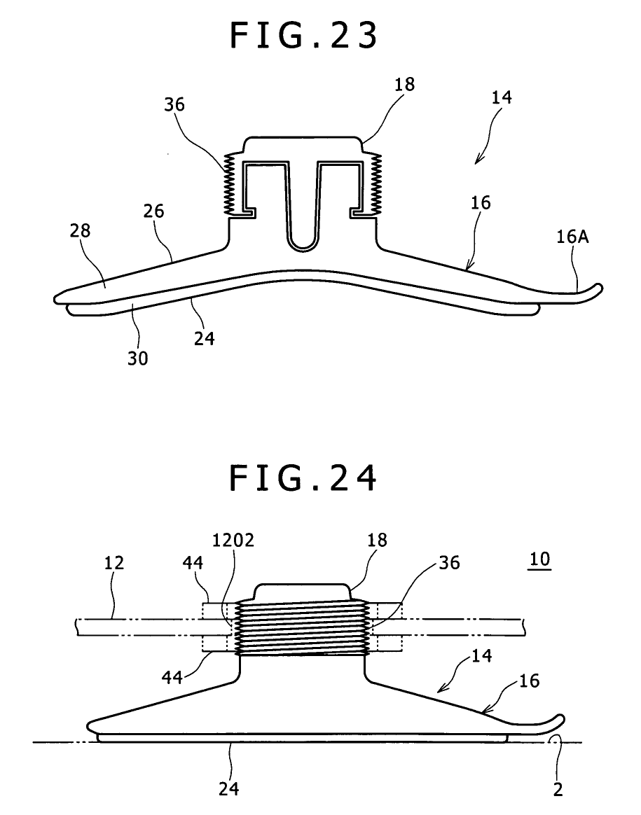

FIGS. 23 and 24 show the suction cup device 14 according to the eighth embodiment of the present invention.

Referring to FIGS. 23 and 24, the suction cup device 14 includes a suction cup 16 and a center stem 18.

One of the opposite faces of the suction cup 16 in the thicknesswise direction is formed as an attaching face 24 while the other face is formed as a rear face 26 of a convex configuration.

The suction cup 16 is made of a synthetic resin material having elasticity, and, for example, urethane-based materials, styrene-based materials, silicon resin-based materials and various elastic materials known in the past which are used for existing suction cups can be used as the synthetic resin material.

A piece portion 16A for being operated to detach the suction cup 16 is provided on an outer edge of the suction cup 16 such that it extends in a diametrically outward direction of the suction cup 16.

Meanwhile, for the attaching face 24, various configurations known in the past can be adopted.

For example, similarly as in the first embodiment, the suction cup 16 may include, for example, a suction cup body 28 in the form of a disk which forms the rear face 26 and a gel layer 30 which forms the attaching face 24 as seen in FIG. 24.

The center stem 18 is provided at a central portion of the rear face 26 of the suction cup 16 and extends in a direction away from the rear face 26.

The male thread portion 36 is provided on the center stem 18.

Also in the eighth embodiment, similarly as in the seventh embodiment, the frame 12 which is connected to an article and has a screw fitting hole 1202 formed therein which allows the male thread portion 36 to be fitted therein and allows tilting movement of the male thread portion 36 fitted therein and the nuts 44 are used to form the article attaching apparatus 10.

In particular, the male thread portion 36 is fitted in the screw fitting hole 1202 and a portion of the frame 12 is held by and between the nuts 44 screwed on the male thread portion 36 with the frame 12 positioned therebetween to connect the suction cup device 14 to the frame 12.

Consequently, the frame 12 and the article connecting member 46 are attached to the attaching object face 2 through a plurality of suction cup devices 14, and by connecting the article connecting member 46 to an article, the article is attached to the attaching object face 2 through the frame 12 and the plural suction cup devices 14.

Also by the eighth embodiment of the present invention, similar advantages to those achieved by the first to seventh embodiments are achieved.

### Ninth Embodiment

Now, a ninth embodiment of the present invention is described.

The ninth embodiment is a modification to but is different from the eighth embodiment in that the suction cup device 14 includes a suction cup body 28, a spring member 50, and a center stem 18.

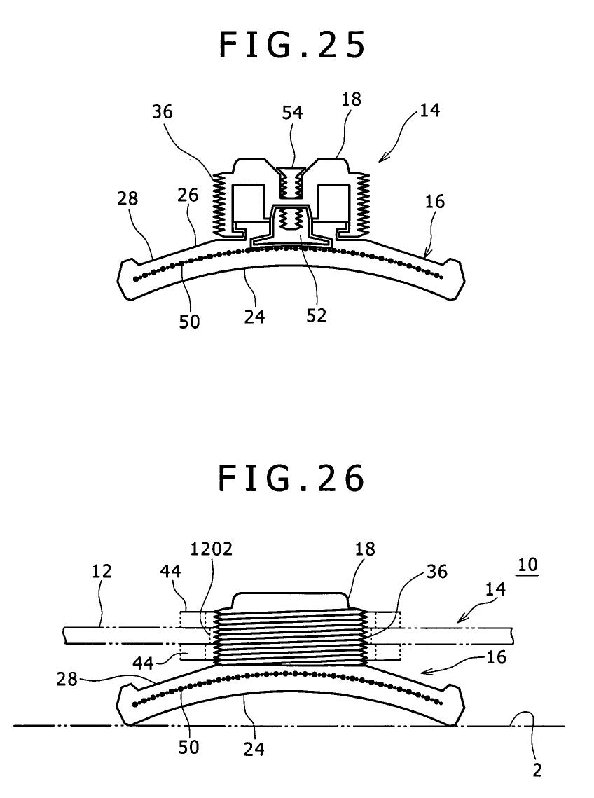

FIGS. 25 and 26 show the suction cup device 14 according to the ninth embodiment.

Referring to FIGS. 25 and 26, the suction cup body 28 has at least one face formed from gel and serving as an attaching face 24.

The spring member 50 is provided in the suction cup body 28 and has a concave shape such that the attaching face 24 has a concave shape. The spring member 50 is formed from an elastically deformable material which biases the center of the attaching face 24 in a direction away from the attaching object face 2 in a state where the attaching face 24 is fixed to the attaching object face 2 by suction.

In the present embodiment, the spring member 50 is formed from a material having an elastic modulus higher than that of natural rubber and synthetic rubber.

It is to be noted that the suction cup 16 is composed of the suction cup body 28 and the spring member 50.

The center stem 18 is provided at a central portion of the rear face 26 of the suction cup 16 and extends in a direction away from the rear face 26.

The male thread portion 36 is provided on the center stem 18.

It is to be noted that the center stem 18 can be attached by various methods.

For example, the center stem 18 may be attached such that a female thread member 52 having a female thread thereon is embedded in the suction cup body 28 made of gel and then the tubular center stem 18 having the male thread portion 36 is attached to the female thread member 52 by means of a screw 54 screwed on the male thread portion 36.

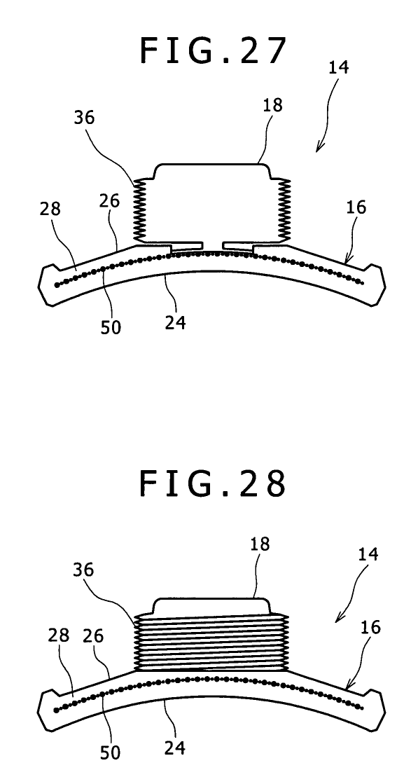

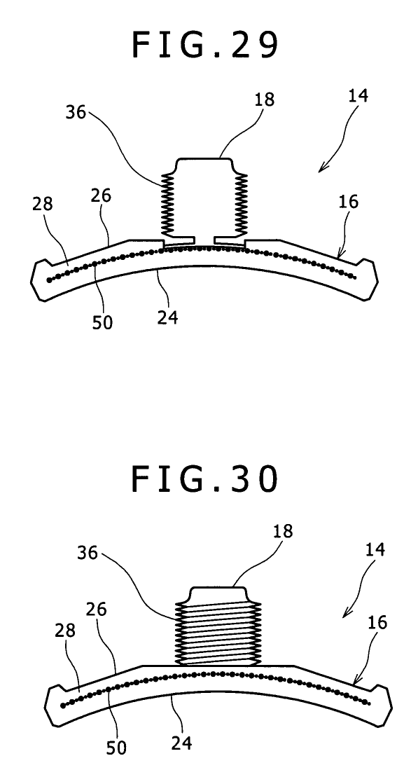

Or, the center stem 18 may be attached such that a lower end of the center stem 18 is coupled to the spring member 50 and the center stem 18, suction cup body 28 and spring member 50 are molded integrally as seen in FIGS. 27 and 29.

Also in the ninth embodiment, similarly as in the first to seventh embodiments, the frame 12 which is connected to an article and has a screw fitting hole 1202 formed therein which allows the male thread portion 36 to be fitted therein and allows tilting movement of the male thread portion 36 fitted therein and the nuts 44 are used to form the article attaching apparatus 10.

In particular, the male thread portion 36 is fitted in the screw fitting hole 1202 and a portion of the frame 12 is held by and between the nuts 44 screwed on the male thread portion 36 with the frame 12 positioned therebetween to connect the suction cup device 14 to the frame 12.

Consequently, the frame 12 and the article connecting member 46 are attached to the attaching object face 2 through a plurality of suction cup devices 14, and by connecting the article connecting member 46 to an article, the article is attached to the attaching object face 2 through the frame 12 and the plural suction cup devices 14.

Also by the ninth embodiment of the present invention, similar advantages to those achieved by the first to seventh embodiments are achieved.

It is to be noted that the article to be supported by the article attaching apparatus 10 is not limited to a vehicle-carried article, an image pickup apparatus, a hanger or the like but may assume various article forms.

It should be understood by those skilled in the art that various modifications, combinations, sub-combinations and alterations may occur depending on design requirements and other factor in so far as they are within the scope of the appended claims or the equivalents thereof.

What is claimed is:

1. A suction cup device, comprising:
a suction cup having
a suction face, and
a rear face along a thicknesswise direction thereof;
a center stem connected to a central portion of the rear face of said suction cup and extending in a direction away from the rear face along the thicknesswise direction;
a case having
a contacting portion capable of contacting with an outer circumferential portion of the rear face of said suction cup or with a portion of an attaching object face outside said suction cup in a state where said case covers the rear face of said suction cup and the suction face of said suction cup is attached to the attaching object face by suction; and
a displacement mechanism provided between said center stem and said case for operating said case to cause said contacting portion of said case to contact with the outer circumferential portion of the rear face of said suction cup or the portion of the attaching object face outside said suction cup to displace said center stem in the direction away from the attaching object face in a state where the suction face of said suction cup is attached to the attaching object face by suction;
said case having
a male thread portion which extends in the direction away from the central portion of the rear face of said suction cup.

2. The suction cup device according to claim 1, wherein said male thread portion of said case is provided coaxially with said center stem.

3. An article attaching apparatus, comprising:
a frame connected to an article; and
a plurality of suction cup devices connected to said frame;
each of said suction cup devices including
a suction cup having
a suction face, and
a rear face along a thicknesswise direction thereof,
a center stem connected to a central portion of the rear face of said suction cup and extending in a direction away from the rear face along the thicknesswise direction
a case having
a contacting portion capable of contacting with an outer circumferential portion of the rear face of said suction cup or with a portion of an attaching object face outside said suction cup in a state where said case covers the rear face of said suction cup and the suction face of said suction cup is attached to the attaching object face by suction, and
a displacement mechanism provided between said center stem and said case for operating said case to cause said contacting portion of said case to contact with the outer circumferential portion of the rear face of said suction cup or the portion of the attaching object face outside said suction cup to displace said center stem in the direction away from the attaching object face in a state where the suction face of said suction cup is attached to the attaching object face by suction,
said case having
a plurality of male thread portions which extend in the direction away from the central portion of the rear face of said suction cup,
said frame having
a plurality of screw fitting holes formed at different positions thereof spaced away from each other and having an inner diameter which allows said male thread portions of said case to be fitted in said screw fitting holes and allows tilting motion of said male thread portions in the state where said male thread portions are fitted in said screw fitting holes,
said male thread portions of said case being fitted in said screw fitting holes in said frame while a pair of nuts are screwed on each of said male thread portions such that said frame is held between and by said nuts to connect said suction cup devices to said frame.

4. The article attaching apparatus according to claim 3, wherein said frame includes
a plurality of plate-formed members of an elongated shape having a length of a dimension greater than a width thereof;
said screw fitting holes being formed at the opposite ends of said plate-formed members in the lengthwise direction;
said plate-formed members being placed one on another at least at one of said screw fitting holes thereof while said male thread portions are fitted in both of the overlapping screw fitting holes and the other screw fitting holes, said plate-formed members being held by and between said nuts screwed on said male thread portions of said case to connect said suction cup devices to said plate-formed members.

5. The article attaching apparatus according to claim 4, wherein each of said plate-formed members is formed from a first plate portion and a second plate portion juxtaposed with each other in the lengthwise direction of the plate-formed member, and
said first and second plate portions extend in parallel to each other and have heights different from each other by an amount equal to the thickness of the plate-formed member.

6. A suction cup device, comprising:
a suction cup having
a suction face, and
a rear face along a thicknesswise direction thereof;
a center stem connected to a central portion of the rear face of said suction cup and extending in a direction away from the rear face along the thicknesswise direction;
a case having
a contacting portion capable of contacting with an outer circumferential portion of the rear face of said suction cup or with a portion of an attaching object face outside said suction cup in a state where said case covers the rear face of said suction cup and the suction face of said suction cup is attached to the attaching object face by suction; and
a displacement mechanism provided between said center stem and said case for operating said case to cause said contacting portion of said case to contact with the outer circumferential portion of the rear face of said suction cup or the portion of the attaching object face outside said suction cup to displace said center stem in the direction away from the attaching object face in a state where the suction face of said suction cup is attached to the attaching object face by suction;
an end portion of said center stem remote from the central portion of the rear face of said suction cup extending through said case so as to be exposed from said case,
said center stem having
a male thread portion provided at the portion thereof exposed from said case.

7. An article attaching apparatus, comprising:
a frame connected to an article; and
a plurality of suction cup devices connected to said frame;
each of said suction cup devices including
a suction cup having
a suction face, and
a rear face along a thicknesswise direction thereof,
a center stem connected to a central portion of the rear face of said suction cup and extending in a direction away from the rear face along the thicknesswise direction,
a case having
a contacting portion capable of contacting with an outer circumferential portion of the rear face of said suction cup or with a portion of an attaching object face outside said suction cup in a state where said case covers the rear face of said suction cup and the suction face of said suction cup is attached to the attaching object face by suction, and
a displacement mechanism provided between said center stem and said case for operating said case to cause said contacting portion of said case to contact with the outer circumferential portion of the rear face of said suction cup or the portion of the attaching object face outside said suction cup to displace said center stem in the direction away from the attaching object face in a state where the suction face of said suction cup is attached to the attaching object face by suction,
said center stem having
a plurality of male thread portions provided at the portion thereof exposed from said case,
said frame having
a plurality of screw fitting holes formed at different positions thereof spaced away from each other and having an inner diameter which allows said male thread portions of said case to be fitted in said screw fitting holes and allows tilting motion of said male thread portions in the state where said male thread portions are fitted in said screw fitting holes,
said male thread portions of said case being fitted in said screw fitting holes in said frame while a pair of nuts are screwed on each of said male thread portions such that said frame is held between and by said nuts to connect said suction cup devices to said frame.

8. A suction cup device, comprising:
a suction cup having
a suction face, and
a rear face along a thicknesswise direction thereof; and
a center stem connected to a central portion of the rear face of said suction cup and extending in a direction away from the rear face along the thicknesswise direction;
said center stem having
a male thread portion provided thereon.

9. An article attaching apparatus, comprising:
a frame connected to an article; and
a plurality of suction cup devices connected to said frame;
each of said suction cup devices including
a suction cup having
a suction face, and
a rear face along a thicknesswise direction thereof, and
a center stem connected to a central portion of the rear face of said suction cup and extending in a direction away from the rear face along the thicknesswise direction,
said center stem having
a plurality of male thread portions provided thereon,
said frame having
a plurality of screw fitting holes formed at different positions thereof spaced away from each other and having an inner diameter which allows said male thread portions of said case to be fitted in said screw fitting holes and allows tilting motion of said male thread portions in the state where said male thread portions are fitted in said screw fitting holes,
said male thread portions of said case being fitted in said screw fitting holes in said frame while a pair of nuts are screwed on each of said male thread portions such that said frame is held between and by said nuts to connect said suction cup devices to said frame.
